(19) United States
(12) Patent Application Publication
(10) Pub. No.: US 2004/0219355 A1
(43) Pub. Date: Nov. 4, 2004

(54) Double-faced silicone adhesive tape and method of use thereof in splicing

(76) Inventors: Michael Clemmens, Glen Rock, PA (US); Colleen McNulty Wagner, Lewisberry, PA (US); Peter D. Gabriele, York, PA (US)

Correspondence Address: BIRCH STEWART KOLASCH & BIRCH, PO BOX 747, FALLS CHURCH, VA, 22040-0747, US

(21) Appl. No.: 10/481,254

(22) PCT Filed: Jun. 21, 2002
(86) PCT No.: PCT/US02/19621

Related U.S. Application Data
(60) Provisional application No. 60/299,751, filed on Jun. 22, 2001.

(51) Int. Cl. B32B 27/12

(52) U.S. Cl. 428/343; 156/157; 442/149; 442/394

(57) ABSTRACT

A double-faced, non-woven supported silicone pressure sensitive adhesive splicing tape comprising a non-woven backing material having opposing porous surfaces, each said surfaces being coated with a pressure sensitive adhesive, with at least one of said surfaces being coated with a silicone pressure sensitive adhesive layer which is coated and cured on said surface. A method of using the double-faced, non-woven supported silicone pressure sensitive adhesive splicing tape to splice substrates having a low energy surface is also provided.

### BACKGROUND OF THE PRESENT INVENTION

The present invention is directed to a non-woven supported silicone pressure sensitive adhesive splicing tape.

Traditional methods employed for use in connection with automated flying splices of silicone release liners involve the use of a layered construction comprised of a single-sided silicone pressure sensitive adhesive tape and a double-faced acrylic tape. The single-sided silicone tape is applied face down to the silicone liner, followed by the application of another single-faced silicone tape face up on the acrylic tape. A total of three strips of tape are accordingly employed from two separate rolls of tape.

In an effort to reduce tape usage/cost, the silicone is occasionally removed from the liner by sanding. When the silicone is sanded off the liner, the acrylic system is applied directly to the raw paper (sanded surface) followed by the silicone tape. The sanding is done in place of the first strip of single-sided silicone tape. The single-faced silicone tapes that are most often used have a solid film polyethylene terephthalate (PET) backing.

Currently, there are some double-sided silicone tapes on the market. They employ a solid film polyester carrier. The solid film has the limitations discussed below.

Conventional splicing methods as discussed above suffer many disadvantages. The silicone adhesive does not adhere well to the PET backing layer absent pretreatment to enhance adhesion. The pretreatment step is costly and time-consuming. Further, conventional pretreatment steps employ large volumes of volatile solvents, which, apart from the added cost, require additional processing steps. The PET backing layer itself often exhibits poor heat resistance. As a result, the PET (even if pre-shrunk), often shrinks in a high temperature environment common to splicing applications. Such shrinkage usually occurs along the X-Y axis due to its uniform orientation resulting from manufacture. Movement or shrinkage of the PET along the X-Y axis results in wrinkling, pulling and/or curling in the web. The acrylic tape used during splicing also possesses disadvantages from the standpoint of temperature resistance. Although shielded to some extent from the effects of elevated temperatures by the silicone tape, the acrylic adhesive system tends to exhibit much less temperature resistance than silicone and will melt under sufficiently extreme conditions. Also, due to the number of tapes required, the caliper (or thickness) of a typical single-faced silicone/double-faced acrylic/single-faced silicone laminate can be in the range of from about 16 to about 20 mils. This results in unnecessary thickness in heavy weight systems where the caliper is already quite high.

U.S. Pat. No. 3,021,250 discloses a double-faced adhesive material which may be used with a non-woven backing.

U.S. Pat. No. 3,015,597 discloses a single-sided pressure sensitive adhesive on a non-woven backing.

U.S. Pat. No. 2,857,356 discloses a silicone pressure sensitive adhesive on a backing.

U.S. Pat. No. 2,882,183 discloses a silicone pressure sensitive adhesive on a glass fabric.

U.S. Pat. No. 4,999,235 discloses a pressure sensitive adhesive on a non-woven fabric.

U.S. Pat. No. 5,198,293 discloses a non-woven cleaning cloth impregnated with a pressure sensitive adhesive.

U.S. Pat. No. 5,227,225 discloses an adhesive layer coated on a non-woven cloth.

U.S. Pat. No. 5,736,470 discloses a pressure sensitive adhesive on a porous substrate which may be a non-woven.

U.S. Pat. No. 5,602,214 discloses the use of a silicone pressure sensitive adhesive on a porous backing such as a glass cloth. The resulting tape may be used in the splicing of low surface energy materials such as siliconized surfaces.

It is thus desirable to provide an improved splicing tape which may be used with advantage with silicone release liners, exhibits resistance to elevated temperatures, and can avoid the use of high caliper constructions.

### OBJECTS AND SUMMARY OF THE PRESENT INVENTION

It is accordingly an object of the present invention to provide a splicing tape that may be used with advantage in connection with the splicing of silicone release liners.

It is further an object of the present invention to provide a splicing tape which exhibits resistance to elevated temperatures.

It is further an object of the present invention to provide a splicing tape which has a desirably low caliper.

It is still further an object of the present invention to provide an improved method for the splicing of a silicone release liner.

In accordance with the present invention, there is thus provided a double-faced, non-woven supported silicone pressure sensitive adhesive splicing tape comprising a non-woven backing material having opposing porous surfaces; and a silicone pressure sensitive adhesive layer coated and cured on at least one surface of said non-woven backing material.

In accordance with the present invention, there is also provided an improved method for the splicing of silicone release liners using the novel splicing tape of the present invention.

### DETAILED DESCRIPTION OF THE PRESENT INVENTION

The novel splicing tape of the present invention is comprised of a double-faced, non-woven supported silicone pressure sensitive adhesive tape.

Applicants have unexpectedly and surprisingly found that the use of a non-woven backing layer in conjunction with at least one layer of silicone pressure sensitive adhesive enables highly desirable advantages to be achieved. Further, the novel splicing tape of the present invention may be used with advantage to splice substrates exhibiting low surface energy such as silicone substrates. The splicing tape of the present invention exhibits quick adhesive and high cohesive strength as well as excellent temperature and chemical resistance.

Advantageously, the silicone pressure sensitive adhesive penetrates the porous structure of the non-woven backing material. In a preferred embodiment where both sides of the non-woven backing are coated with a silicone pressure sensitive adhesive, the adhesive is caused to link with the silicone pressure sensitive adhesive on the opposing side of the non-woven matrix. Such self-linking between opposing sides of the backing material enhances the structural stability of the tape. The ability to use a non-woven backing material enables the use of more costly backing materials such as PET to be avoided. Also, the silicone adhesive bonds to the non-woven material without the need to pretreat the surface of the material as is normally the case with backing materials comprised of polymeric films such as polyester backing films.

While it is preferred to coat both sides of the non-woven backing material with a silicone pressure sensitive adhesive, it is also within the scope of the present invention to coat only a single side of the non-woven material with a silicone pressure sensitive adhesive. The remaining side can be coated with a non-silicone pressure sensitive adhesive such as vinyl copolymers; acrylic polymers, copolymers and terpolymers; polyurethane polymers, heat-activated adhesives systems, rubber-based adhesives such as polyisobutylene and blends thereof with, for example, natural rubber, etc. Hot melt adhesives may also be applied in place of the non-silicone pressure sensitive adhesive on the non-woven backing material.

Any conventional silicone pressure sensitive adhesive can be employed in the present invention. See, for example, U.S. Pat. Nos. 2,882,183; 2,857,356; and 5,602,214, each herein incorporated by reference in their entireties. The selection of the non-woven material is not critical to practice of the present invention, and a wide variety of non-woven materials may be employed in the present invention. The only requirement is that the non-woven material be sufficiently porous to permit the pressure sensitive adhesive to be able to fill porous areas of the backing and enhance bonding of the silicone adhesive to the backing layer.

Exemplary non-woven materials may be comprised of a number of materials, such as those selected from the group consisting of paper, wood pulp, wood fiber, cotton, glass, polyester, polypropylene, blends of polyolefin/polyvinyl alcohol, polyester blends, bicomponent polyethylene/polypropylene, aramid, PEEK, metallic fibers (such as stainless steel, steel, nickel, nickel/copper and silver-plated), liquid crystalline polymers, polyolefins, polytetrafluoroethylene, and carbon fibers.

Exemplary nonwoven fibers include a nickel/copper polyester nonwoven material marketed under the mark FLECTRON by Advanced Performance Materials, FIBREX nickel fiber marketed by National Standard, and a silver-coated fabric marketed under the mark CFT by Schlegel.

It has been unexpectedly found that when a silicone pressure sensitive adhesive is used on at least one side of the non-woven backing material, and in such a manner as to impregnate the non-woven material, the physical properties of the non-woven material (such as temperature or chemical resistance) can be materially improved. For instance, a non-woven material comprised of PET (which would normally exhibit very poor temperature resistance) can, when impregnated with the silicone pressure sensitive adhesive, exhibit a temperature resistance orders of magnitude higher than would otherwise be the case. Also, the overall physical properties of the tape can be modified depending upon the identity of the non-woven material which is used as the backing material. For instance, the use of a non-woven material comprised of metal fibers such as steel fibers results in a non-woven material possessing both high strength and temperature resistance.

As the non-woven tends to not have a uniform X-Y direction, in the event that any shrinkage occurs, any shrinkage will be non-uniform. Indeed, the fact that the adhesive has interpenetrated the non-woven backing material tends to restrict any shrinkage due to reinforcing provided by the adhesive matrix. The fact that a non-woven matrix is employed also enhances the ability of the resulting tape to exhibit greater flexibility than if a more rigid backing film was used. This enables the tape to be more easily processed through roller systems during the splicing operation. As only one layer is required, the caliper of the splicing tape of the present invention can be as low as 6 mils or so.

The tape of the present invention can be manufactured by conventional means. A desired non-woven material is provided, which is coated on each side with at least one layer of silicone pressure sensitive adhesive, and on the other side with a silicone pressure sensitive adhesive or other conventional pressure sensitive adhesive (or hot melt adhesive in a non-splicing environment). Preferably, the porous structure of the non-woven material is substantially completely impregnated with the silicone adhesive. If both sides of the non-woven material are coated with the silicone pressure sensitive adhesive, then in a most preferred embodiment the opposing surfaces of the pressure sensitive adhesive are caused to link together through the porous matrix of the non-woven material, subsequent to which the respective adhesive layers are cured as necessary. It is particularly desired in connection with the present invention for the respective layers of adhesive to penetrate the pores of the non-woven substrate which enhances the bonding of the adhesive to the substrate.

The adhesive can be coated using any conventional coating technique, including roll techniques such as reverse-roll, knife-over-roll, gravure coating and the like. The amount of adhesive applied can be varied to accommodate the type of nonwoven and the properties desired. The silicone adhesive is first dried and then cured at a temperature of up to 350° F.

The tape of the present invention finds particular advantage in splicing of substrates having low surface energy surfaces, such as siliconized surfaces, in a conventional manner.

The splicing tape of the present invention can be used for manual, overlap splicing applications, flying splices and zero speed splices in a conventional manner. In manual, overlap splices the tape is applied to the incoming roll. The expiring web edge is then brought into contact with the exposed portion of the double-sided tape manually. The result is a bond between the expiring web edge and the incoming web edge to provide a continuous process. Unfortunately, the web must be stopped in order to make the splice resulting in down-time and raw material loss.

In flying splice applications the splicing tape is used to join the expiring web with the incoming web without stopping or reducing processing speeds. The splice can be made at the standard processing speed resulting in a reduction in down-time and material loss. The tape is applied to the leading edge of the new roll. The splicing tape may be in several configurations. Tabs are used to secure the web edge to the roll and prevent air from lifting the edge during speed match. The roll is then brought up to speed to match the process speed. The splicing sequence is then initiated. The tape must provide sufficient adhesion to the substrate to form an instantaneous bond. A knife cuts the expiring web, and the process continues without disruption.

As with flying splices, zero speed splices are intended to reduce down time and material loss by making the splice at production speed without stopping. In contrast to the flying splice, the splice is made at a stand still. An accumulator system is employed to retain enough footage to continue the process while the unwind is automatically stopped and the splice is made. The entire process is generally automated and requires extreme timing to ensure that the splice is made before the accumulated material is diminished.

The present invention will be demonstrated by the following example, which is intended to be merely exemplary in character and not limiting in scope of the present invention.

### EXAMPLE

A splicing tape prepared in accordance with the present invention was evaluated to determine its acceptability as a splicing tape.

The tape construction used in the Example provided was a 1.90 osy to 2.10 osy per side silicone adhesive with a polyester nonwoven carrier using a double release linered system. The polyester nonwoven carrier used was 3 mils thick and had a porosity of 275 cfm/ft² at 0.5″ H₂O. The adhesive was coated with a reverse roll technique. Table 1 shows the physical properties of the adhesive construction.

The test methods used to characterize the pressure sensitive adhesive include the following: peel adhesion against steel plate was determined with a Thwing Albert, model QCII-XS tester, using 180 degree pull at a rate of 12 inches per minute, according to PSTC-3. Peel adhesion to polypropylene and high density polyethylene were determined with a Lab Master Release and Adhesion tester, using 180 degree pull at a rate of 12 inches per minute, according to PSTC-3.

The adhesion to silicone release liner was determined on a Thwing Albert model QCII-XS using a 180 degree pull rate of 12 inches per minute. The silicone liner was a commercially available standard product from P.H. Glatfelter Co.

One inch strips of manually made overlap splices were tested at various temperatures for tensile strength. The strips were tested on an Instron Model 4201 at 0.5 inch per minute.

The following testing results were determined:

| | | | |
|---|---|---|---|
| Peel to SS (oz./in) | 73 | Tensile @ 200° F. (lb/in) | 21 |
| Peel to PP (oz./in) | 51 | Tensile @ 250° F. (lb/in) | 14 |
| Peel to HDPE (oz./in) | 44 | Tensile @ 300° F. (lb/in) | 9 |
| Peel to silicone liner (oz./in) | 52 | Tensile @ 350° F. (lb/in) | 7 |

The substrate tested was 60# Kraft super calendered paper coated with an easy release solventless silicone on each side. The tape was able to successfully make flying splices at speeds of up to 1500 feet per minute (fpm) with a tension of 2 lbs/linear inch (pli). The tape also successfully made flying splices at 1500 fpm with a tension of 4 lbs/linear inch (pli). The tape also successfully made splices at low speeds (200 ft/min) and high web temperatures (333° F.) at 2 lbs/linear inch. The splices were also successful at low speed and high temperatures at 4 lbs/linear inch. In an extreme case, the splices were successfully passed through ovens with web temperatures in excess of 450° F. The splice did, however, fail at one 90 degree turn outside of the oven due to the effect of the extreme heat, with the heat discoloring the paper silicone liner.

1. A double-faced, non-woven supported silicone pressure sensitive adhesive splicing tape comprising a non-woven backing material having opposing porous surfaces, each said surfaces being coated with a pressure sensitive adhesive, with at least one of said surfaces being coated with a silicone pressure sensitive adhesive layer which is coated and cured on said surface.

2. The splicing tape of claim 1, wherein said silicone pressure sensitive adhesive is coated on both sides of said non-woven backing material.

3. The splicing tape of claim 1, wherein one surface of said non-woven backing material is coated with a non-silicone pressure sensitive adhesive.

4. The splicing tape of claim 3, wherein said non-silicone pressure sensitive adhesive is selected from the group consisting of vinyl copolymers, acrylic polymers, acrylic copolymers, acrylic terpolymers, heat-activated adhesives, polyurethane polymers, and rubber-based adhesives.

5. The splicing tape of claim 1, wherein one surface of said non-woven backing material is coated with a non-silicone hot melt adhesive.

6. The splicing tape of claim 1, wherein said non-woven material is selected from the group consisting of paper, wood pulp, wood fiber, cotton, glass, polyester, polypropylene, blends of polyolefin/polyvinyl alcohol, polyester blends, bicomponent polyethylene/polypropylene, aramid, PEEK, metal, liquid crystalline polymers, polyolefins, polytetrafluoroethylene and carbon fibers.

7. The splicing tape of claim 1, wherein said non-woven material comprises metallic fibers and said non-woven material is coated on both sides with said silicone pressure sensitive adhesive.

8. The splicing tape of claim 7, wherein said metal fibers are selected from the group consisting of steel, stainless steel, nickel, nickel/copper and silver plated fibers.

9. The splicing tape of claim 1, wherein said non-woven material is substantially completely impregnated by said pressure sensitive adhesives.

10. The splicing tape of claim 2, wherein said non-woven material is substantially completely impregnated by said silicone pressure sensitive adhesive.

11. The splicing tape of claim 6, wherein said non-woven material is substantially completely impregnated by said pressure sensitive adhesives.

12. The splicing tape of claim 7, wherein said non-woven material is substantially completely impregnated by said silicone pressure sensitive adhesive.

13. In a method of splicing substrates having a low energy surface, comprising joining said substrates together by application of a pressure sensitive adhesive splicing tape, the improvement wherein said splicing tape comprises a non-woven backing material having opposing porous surfaces, each said surfaces being coated with a pressure sensitive adhesive, with at least one of said surfaces being coated with a silicone pressure sensitive adhesive layer which is coated and cured on said surface.

14. The method of claim 13, wherein said silicone pressure sensitive adhesive is coated on both sides of said non-woven backing material.

15. The method of claim 13, wherein one surface of said non-woven backing material is coated with a non-silicone pressure sensitive adhesive.

16. The method of claim 15, wherein said non-silicone pressure sensitive adhesive is selected from the group consisting of vinyl copolymers, acrylic polymers, acrylic copolymers, acrylic terpolymers, heat-activated adhesives, polyurethane polymers, and rubber-based adhesives.

17. The method of claim 13, wherein one surface of said non-woven backing material is coated with a non-silicone hot melt adhesive.

18. The method of claim 13, wherein said non-woven material is selected from the group consisting of paper, wood pulp, wood fiber, cotton, glass, polyester, polypropylene, blends of polyolefin/polyvinyl alcohol, polyester blends, bicomponent polyethylene/polypropylene, aramid, PEEK, metal, liquid crystalline polymers, polyolefins, polytetrafluoroethylene and carbon fibers.

19. The method of claim 13, wherein said non-woven material comprises metallic fibers and said non-woven material is coated on both sides with said silicone pressure sensitive adhesive.

20. The method of claim 19, wherein said metal fibers are selected from the group consisting of steel, stainless steel, nickel, nickel/copper, and silver-plated fibers.

21. The method of claim 13, wherein said non-woven material is substantially completely impregnated by said pressure sensitive adhesives.

22. The method of claim 14, wherein said non-woven material is substantially completely impregnated by said silicone pressure sensitive adhesive.

23. The method of claim 18, wherein said non-woven material is substantially completely impregnated by said pressure sensitive adhesives.

24. The method of claim 19, wherein said non-woven material is substantially completely impregnated by said silicone pressure sensitive adhesive.
